(19) United States
(12) Patent Application Publication
(10) Pub. No.: US 2005/0160774 A1
(43) Pub. Date: Jul. 28, 2005

(54) Multimedia security case system with slide lock and key

(76) Inventors: Marshall Weinstein, Riverwoods, IL (US); Kenneth Muderlak, Milwaukee, WI (US)

Correspondence Address: William P. Oberhardt;William P.Oberhardt, LLC, 2100 Three First National Plaza, Chicago, IL, 60602-4253, US

(21) Appl. No.: 10/764,325

(22) Filed: Jan. 23, 2004

(51) Int. Cl. E05B 73/00

(52) U.S. Cl. 70/57.1; 70/63

(57) ABSTRACT

A multimedia security case combined with a slide lock and key includes a cover attached to a base with a hinge located between them, and is moveable between an open and closed position. The cover and base both have flanged tongue half portions having apertures which, when the security case is closed, together form a flanged tongue having apertures that serve as locking bar receptacles. The slide lock slides onto the flanged tongue clamping the case shut, and, has locking bars that engage the locking bar receptacles, preventing disengagement of the lock without the key of the invention. A key is provided having key teeth that disengage the locking bars from the apertures while simultaneously causing the removal of the slide lock from the case so that it may be opened.

### BACKGROUND OF THE INVENTION

1. Field of the Invention

The present invention relates to reusable security cases for multimedia systems such as those that are commonly referred to as DVDs, CDs, or video game discs (collectively referred to herein as “multimedia discs”), although the invention can relate as well to reusable security cases for non-disc multimedia systems. The invention in particular relates to a replaceable, removable C-channel slide lock that slides onto and clamps over a flanged tongue formed partially on both the cover and base of a hinged multimedia security case and engages that flanged tongue of the security case in such a manner that it maintains the security case in a closed position preventing the removal of the multimedia disc or discs inside until such time as a mechanical key of the invention disengages the C-channel slide lock from the security case so that the C-channel slide lock may be removed from the security case and the security case may be opened. No electrical or magnetic components are required to carry out the invention.

2. Brief Description of the Related Art

Video rental stores and libraries experience problems with the theft of multimedia discs from cases used to contain, protect, and sometimes display the discs. While retailers who sell multimedia discs also experience theft problems and attempt to deter theft of multimedia discs from cases by applying, among other devices, various adhesive labels that render opening of the cases more difficult and time-consuming, and while such adhesive labels are tamper-evident because the adhesive labels must be destroyed in order to open the case, such a theft-deterrent approach is impractical and ineffective for video rental stores and libraries, which rent or lend the same multimedia disc on multiple occasions, and thus are required to reuse the case and install the theft prevention device repeatedly. Video rental stores and libraries require a reliable, reusable, economical system for deterring and preventing theft of multimedia discs from security cases that cannot easily be overcome by potential thieves. Advantageously, such systems would not appreciably change the size and shape of the existing display, storage, or security cases, so that special shelving and fixtures would not be required to accommodate the system. Also advantageously, such systems would be quick and easy to operate, would not require special electronics or electrical connections, would be readily relocatable, would not utilize magnets (which increase the cost of the system, which can sometimes lose strength and become unreliable, which sometimes require rather precise orientation and thus can be time-consuming to use, and which can impair the ability to read magnetically encoded strips commonly found on credit cards, debit cards, and some library cards if brought in proximity thereto during checkout), and would be relatively inexpensive.

Other reusable security systems, such as those disclosed in U.S. Pat. Nos. 5,460,266 (Mundorf, et al); 5,211,283 (Weisburn, et al); 4,834,238 (Hehn et al); and 4,589,549 (Hehn) have the disadvantage of significantly altering and increasing the size and/or altering the shape of the case so that shelving and fixtures either hold less cases, or need to be redesigned or replaced in order to hold the security cases.

While magnetic security systems such as those disclosed in the U.S. Pat. Nos. 5,598,728 (Lax), and 5,850,752 (Lax) have been disclosed, such systems have the potential disadvantages of magnetic systems discussed above, for example, requiring that the magnet be accurately oriented in order for decoupling of the security device to occur. Orienting the magnet accurately vis-à-vis the decoupler often requires several attempts. In addition, magnets are a disadvantage in that, when at the checkout counter, if magnetically recorded media (such as credit cards, library cards, or the like) are brought in close proximity to the activated magnet, damage can occur by erasing of that media. Furthermore, such magnetic systems often utilize electromagnets and associated electronics, which may require rewiring if relocated.

Still other security systems, such as those illustrated in U.S. Pat. No. 5,375,712 (Weisburn) disclose locking mechanisms that have the disadvantage of being subject to relatively unsophisticated methods of tampering, such as disengaging the locking mechanism by simultaneously inserting pins or even paper clip ends into the lock access openings, which are oriented in the same direction.

### BRIEF SUMMARY OF THE INVENTION

In view of the foregoing, it is an object of the invention to provide a security case for multimedia discs that deters or prevents theft of multimedia discs from cases utilized by video rental stores, libraries, and the like, and which overcomes the above-noted disadvantages of the prior art.

It is a further object of the invention to provide a theft deterrent or theft preventative security case for multimedia discs that does not require utilization of magnetic, electromagnetic, or electronic means to engage or disengage the locking mechanism.

It is a still further object of the invention to provide a theft deterrent or theft preventative security case for multimedia discs that does not appreciably alter the size or shape of an ordinary storage case for multimedia discs, so that significant additional shelf space will not be occupied, and so that it will not be necessary for shelving and storage racks to be redesigned or replaced.

It is a still further object of the invention to provide an easy-to-operate and quick system of locking and disengagement of the lock for security cases for multimedia discs.

It is yet another object of the invention to provide a relatively inexpensive locking mechanism that is difficult to disengage from the security case using means other than that provided by the invention, and especially using relatively unsophisticated means to disengage or “pick” the lock such as, for example, pins or ends of paper clips as lock “picking” devices.

It is a still further object of the invention to provide a security case for multimedia discs that permits a rapid and straightforward procedure for disengaging locks from the security case only when using the lock disengagement device provided by the invention.

It is yet another object of the invention to achieve the aforementioned objects in connection with security cases for a variety of multimedia systems, including non-disc systems.

The present invention achieves the aforementioned objects and others because it includes several features not found in prior art security cases for multimedia discs. In the present invention, a hinged multimedia security case is preferably constructed of a relatively sturdy plastic, such as polypropylene. The hinged multimedia security case defines an internal cavity, which preferably contains one or more retention mechanisms, such as retention hubs for retaining one or more multimedia discs. The case may be translucent or transparent if display of the enclosed multimedia discs is desired, but preferably is opaque for aesthetic purposes and/or for organizational purposes (for example, all comedy DVDs might be stored by a video rental store in opaque yellow cases, while all drama DVDs might be stored in opaque black cases, and all music DVDs might be stored in opaque green cases, etc., so that the cases can be more quickly sorted and stored in their proper shelf location). Similarly, the multimedia security cases might be opaque containing the library's or video rental store's information printed thereon, The multimedia security case hinge is preferably a “living hinge,” as is known in the art.

Preferably, the edge of the multimedia security case that is opposite the hinged spine of the case has a flanged tongue formed partially on the edge of the base and partially on the edge of the cover so that when the case is closed, the two partial flanged tongues cooperate to form an entire a flanged tongue. The flanged tongue has a plurality of locking bar receptacles preferably located on both the cover and base portions of the flanged tongue. A slide lock formed in the shape of a C-channel slides over the flanged tongue so as to fit snugly over the flanged tongue, preventing the cover and base from being separated and opened, and thus preventing unwarranted access to the interior cavity of the multimedia security case which contains the multimedia disc or discs. The slide lock preferably has a plurality of locking bars within the C-channel where they are difficult to access without using the key of the invention. The locking bars are preferably barbed with catches, and are biased to engage the locking bar receptacles in the flanged tongue that are preferably located on both the cover and base at the flanged tongue portions. The barbed locking bars of the slide lock cannot be readily disengaged from the locking bar receptacles of the flanged tongue except by using the mechanical key provided with the invention. A key is provided to disengage the slide lock from the multimedia security case, with the key having a channel formed therein. When the multimedia security case having the slide lock in place slides through the channel of the key, key teeth extending into the channel simultaneously engage the locking bars and cause the barbs to disengage from the locking bar receptacles. The case can then slide free of the slide lock, which is retained by the key. This unlocks the cover and base portions of the flanged tongue. The slide lock may be thereupon disengaged from the key and used to lock other multimedia security cases. The multimedia security case, having the slide lock removed, may now be opened, and the multimedia disc or discs within the cases may be removed by the customer or borrower.

In practice, multimedia security cases having slide locks placed thereon may be reviewed in or retrieved from publicly accessible bins or shelves, and are brought by patrons to the checkout desk for the video rental store or library. The slide locks are already on the multimedia security cases when they are publicly accessible, and that prevents or deters patrons from easily removing the discs from the multimedia security cases, concealing the discs, and/or removing the discs from the store or library. Only the checkout desk has the key to disengage the multimedia security cases' slide lock. The key is preferably firmly affixed to the checkout desk by either a permanent or semi-permanent means (such as by screws or strong adhesive). The patron brings the selected multimedia disc product in the multimedia security case with the slide lock locked in place to the checkout desk and, after paying for the rental or checking out the selection with the library, the attendant slides the locked multimedia security case through the channel of the key, and the key disengages and removes the slide lock so that the patron can then open the case, remove the multimedia disc from the security case, and utilize the multimedia disc. The multimedia security case further serves to protect the disc from damage during the period of rental or borrowing. Upon return of the multimedia disc inside the case, the slide lock is replaced so that the multimedia security case cannot then be opened, and the locked case is replaced on the shelves or bins where it can once again be reviewed and retrieved by patrons.

### BRIEF DESCRIPTION OF THE DRAWINGS

FIG. 1 is a perspective view of the inner portion of an open multimedia security case having cover and base flange halves according to the present invention;

FIG. 2 is a perspective view of the cover side and top edge of the multimedia security case, and corresponding view of the slide lock, with the case in the closed, unlocked position and the slide lock removed;

FIG. 3 is a perspective view of the cover side and top edge of the multimedia security case, and corresponding view of the slide lock, in the closed, locked position with the slide lock in place on the flanged tongue of multimedia security case;

FIG. 4 is a perspective view of the cover side and top edge of the multimedia security case, and corresponding view of the slide lock, in the closed, locked position with the slide lock engaged with the flanged tongue of the multimedia security case, together with the key, and with the locked multimedia security case positioned to slide through the key in order to unlock it;

FIG. 5 is a top sectional view of the slide lock through the lock outer grooves on the slide lock;

FIG. 6 is a top sectional view of the slide lock similar to FIG. 5 with the slide lock engaged with the flanged tongue of the locked multimedia security case, with the case shown sectionally through the flanged tongue of the case, and a top view of the key with the first and second housing covers removed showing the interior of the key, with the locked multimedia security case positioned to begin to slide through the key;

FIG. 7 is a top sectional view similar to FIG. 6 with the multimedia security case having been advanced in a sliding manner and positioned such that all of the key teeth of the key are engaging all of the locking bars of the slide lock;

FIG. 8 is a top sectional view similar to FIG. 7 with the multimedia security case having been advanced in a sliding manner in the key such that the case has begun to separate from the slide lock, with the slide lock being retained by the key;

FIG. 9 is a top sectional view similar to FIG. 8, with the multimedia security case having been further advanced in a sliding manner as compared to FIG. 8, and after the multimedia security case (not shown) has been unlocked and removed from the slide lock, with the slide lock continuing to be retained by the key;

FIG. 10 is a perspective view of the base side and top edge of the multimedia security case at the flanged tongue of the multimedia security case, and a perspective view of the open end of the slide lock, illustrating the manner in which the open end of the slide lock fits on the open end of the flanged tongue; and

FIG. 11 is a side sectional view of the slide lock engaged with the flanged tongue of the multimedia security case.

### DETAILED DESCRIPTION OF THE INVENTION

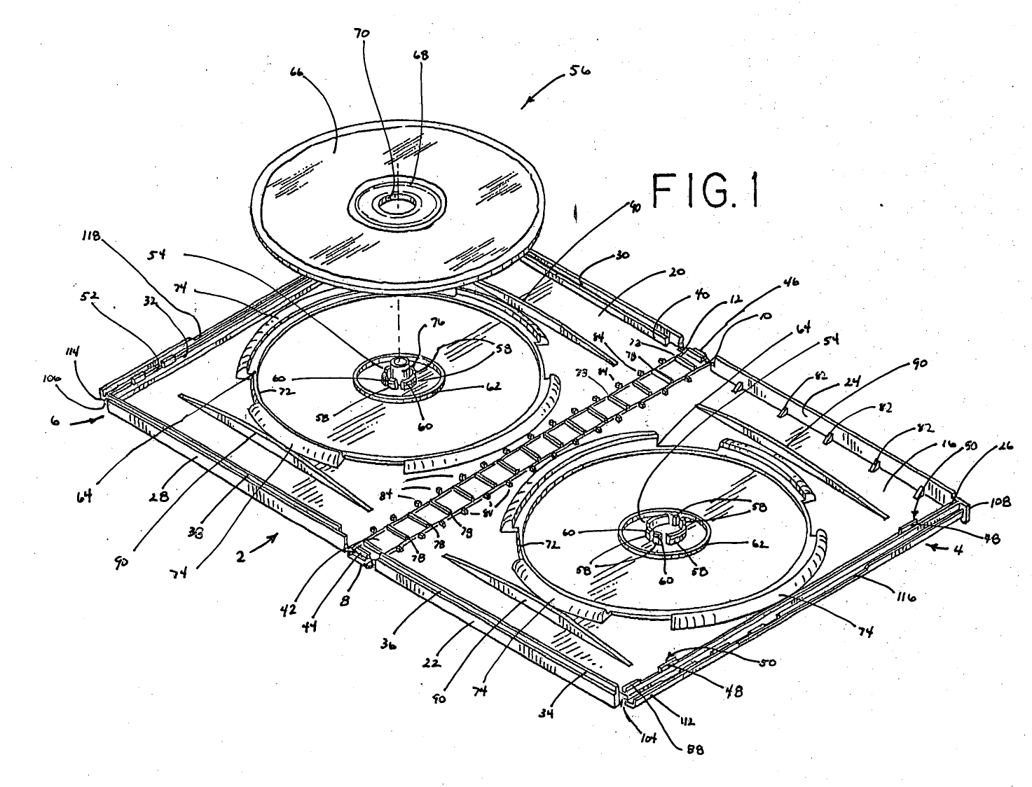

As illustrated in FIGS. 1 through 4, and 10, the multimedia security case 2 has a cover 4, a base 6, and preferably a spine 8. The spine 8 is preferably attached to the base 6 and cover 4 by either or both of a cover hinge 10 and base hinge 12. Preferably, “living hinges,” known in the art, are used for the cover and base hinges 10 and 12. Alternatively, the spine itself may be hinged (not illustrated). Cover 8 has an outer cover surface 14 and an inner cover surface 16. Base 6 has an outer base surface 18 and an inner base surface 20. Top cover edge 22 is formed as a lip adjacent to and projecting inward from the inner cover surface 16 of cover 4, and bottom cover edge 24 is likewise formed as a lip adjacent to and projecting inward from inner base surface 20 of cover 4. Bottom cover edge 24 is located opposite top cover edge 22. Both bottom cover edge 24 and top cover edge 22 are adjacent to spine 8 when multimedia security case 2 is in the closed position (see FIG. 3).

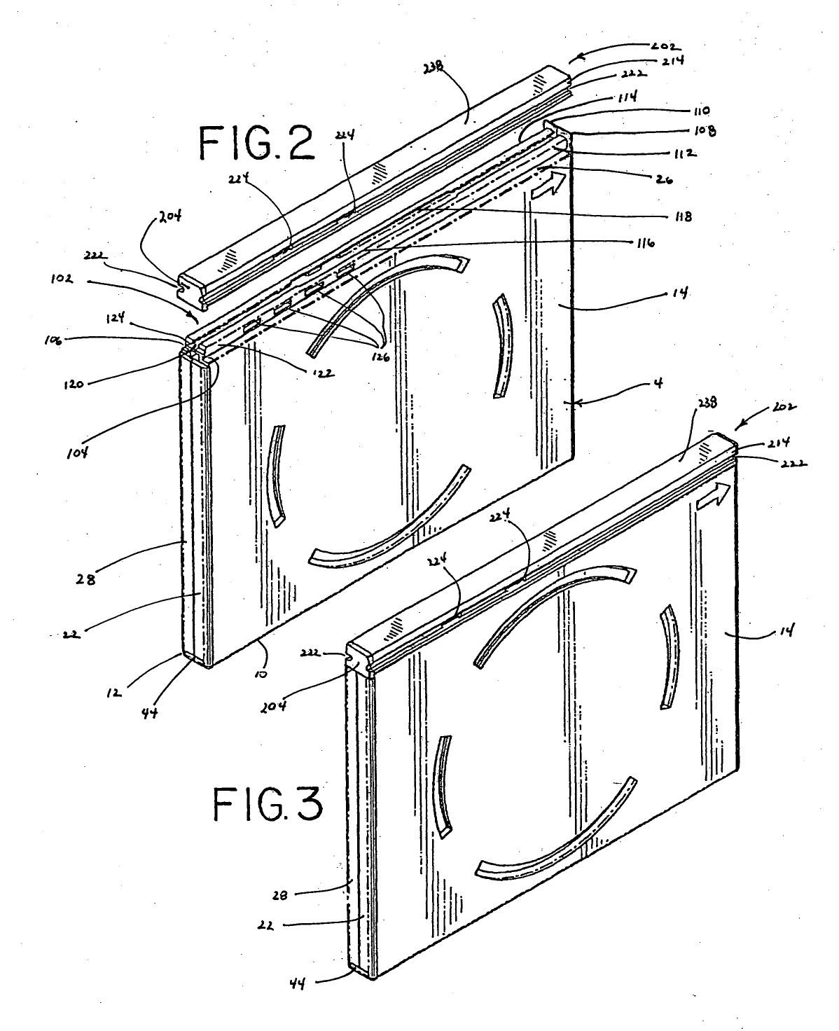

Located on the cover 4 opposite the portion of the cover 4 adjacent to the spine 8, and between top cover edge 22 and bottom cover edge 24, is the cover side edge 26. Cover side edge 26 is formed in part as a lip extending inward from inner cover surface 16 and preferably is integrally connected with top cover edge 22 and bottom cover edge 24. Cover side edge 26 is formed in a manner that will engage with base side edge 32 when multimedia security case 2 is in the closed position (FIGS. 2 through 4, 10, and 11) in order to form flanged tongue 102 so as to accommodate slide lock 202, as described below. In other words, cover side edge 6 preferably includes one portion of flanged tongue 102.

In a similar manner to the cover 4, base 6 has a top base edge 28 formed as a lip adjacent to and projecting inward from inner base surface 20 of base 6. Bottom base edge 30 is formed as a lip adjacent to and projecting inward from inner base surface 20 of base 6. Bottom base edge 30 is located opposite top base edge 28. Both bottom base edge 30 and top base edge 28 are adjacent to spine 8 when multimedia security case 2 is in the closed position.

While a variety of sizes, shapes, and internal configurations may be utilized for multimedia security case 2 without departing from the invention, one preferred embodiment is described below. Located on the inner base surface 20 of base 6 opposite the portion of the base 6 adjacent to spine 8, and between top base edge 28 and bottom base edge 30, is the base side edge 32. Base side edge 32 is formed in part as a lip extending inwardly from inner base surface 20, and preferably is integrally connected with top base edge 28 and bottom base edge 30. As previously described, base side edge 32 is formed in a manner that will engage with cover side edge 26 in order to form flanged tongue 102 that will accommodate slide lock 202 in a manner described below. Thus, base side edge 32 preferably includes the other portion of flanged tongue 102, with the first portion of flanged tongue 102 being preferably included on cover side edge 26, as described above.

As illustrated in FIG. 1, formed as part of top cover edge 22 is top cover edge lip 34, which extends inwardly from top cover edge 22. Bottom cover edge lip 36 is similarly formed as part of bottom cover edge 24. Proximate to and located more inwardly than top base edge 28 is top lip retainer 38 which extends inwardly from inner base surface 20. Top lip retainer 38 preferably runs parallel to top base edge 28 and is located such that, when multimedia security case 2 is in the closed position, top base edge 28 and top lip retainer 38 cooperate in such a manner as to surround and engage top cover edge lip 34. Similarly, proximate to and located more inwardly than the bottom base edge 24 is bottom lip retainer 40, which extends inwardly from inner base surface 20, and preferably runs parallel to bottom base edge 30. Bottom lip retainer 40 and bottom base edge 30 cooperate in a manner so as to surround and engage bottom cover edge lip 36 when multimedia security case 2 is in the closed position.

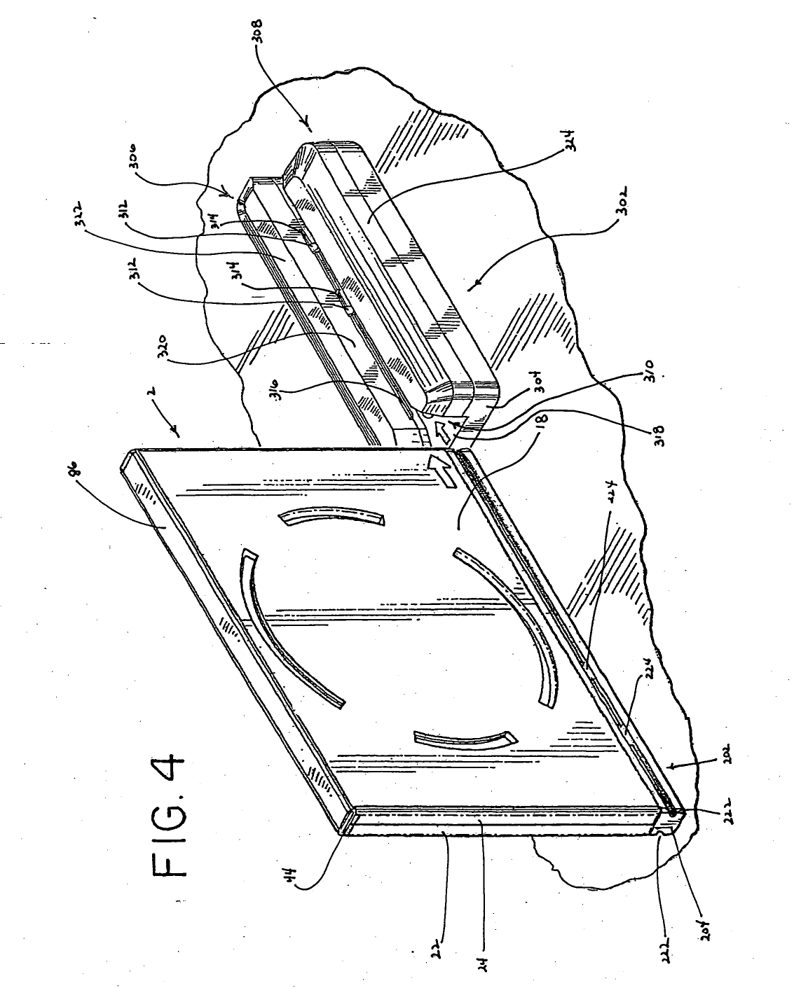

Located on the inner spine surface 42 are top spine edge 44 and bottom spine edge 46, both of which extend inwardly from inner spine surface 42. Top spine edge 44 is located so as to cooperate with top cover edge 22 and top base edge 28 when multimedia security case 2 is in the closed position so as to prevent or deter access to the contents of the case such as by prying. (See FIGS. 2 and 3). Bottom spine edge 46 similarly cooperates with bottom cover edge 24 and bottom base edge 30 when multimedia security case 2 is in the closed position so as to achieve the same result. (See FIG. 4).

One or more closure tabs 48 may be located on either the cover side edge 26 or the base side edge 32. In the embodiment illustrated in FIG. 1, closure tabs are located on cover side edge 26, and extend inwardly from the inner cover surface 16. Closure tabs 48 include closure tab lips 50. One or more closure receptacles 52 may be located on either the base side edge 32 or the cover side edge 26, and engage closure tabs 48 when multimedia security case 2 is in the closed position. In the embodiment illustrated in FIG. 1, closure receptacles 52 are formed as part of base side edge 32. Alignment tabs 54 are preferably located adjacent to closure receptacles 52, here shown on base side edge 32. When multimedia security case 2 is in the closed position, closure tab lips 50 engage closure receptacles 52 to maintain the closed position for multimedia security case 2. Closure tabs 50 are sufficiently flexible such that closure tab lips 52 may be disengaged by pulling on the base 6 and cover 4 (preferably at the cover and base finger indents 116 and 118, described below) to open the multimedia security case 2.

One or more edge alignment tabs 88 aid in the alignment of closure tab lips 50 and closure receptacles 52, and aid in preventing inadvertent disengagement of same.

As illustrated in FIGS. 2 and 3, when multimedia security case 2 is in the closed position, cover 4, base 6, spine 8, top cover edge 22, bottom cover edge 24, cover side edge 26, top base edge 28, bottom base edge 30, and base side edge 32, and their component parts, cooperate with one another so as to define a substantially closed cavity of multimedia security case 2. The closed cavity may house one or more forms of multimedia systems, such as disc forms, for example one or more DVDs, CDs, or video game discs, or even non-disc multimedia systems. While it will be recognized by persons skilled in the art that the multimedia security case 2 may be sized and internal retention mechanisms may be utilized so as to accommodate these different multimedia systems, including accommodating more than one multimedia system in a single case, in order to avoid an unnecessarily lengthy description of the invention, the description of the invention henceforth will be directed to a case that accommodates DVD discs, despite the fact that other multimedia systems may be accommodated without departing from the invention.

Disc retention hub 54 for retaining a DVD disc 56 may be located either on the inner cover surface 16 or inner base surface 20, or both, and, in the embodiment illustrated, in FIG. 1, disc retention hubs 54 are located on both. The discussion that follows is directed to the disc retention hub 54 located on inner cover surface 16, but applies as well to the disc retention hub 54 illustrated on the inner base surface 20.

Disc retention hub 54 may take the form of any number of disc retention systems known in the art without departing from the invention described herein for retaining multimedia discs in cases and, in the illustrated embodiment, preferably takes the form of flexible hub portions 58 having angular retention ridges 60. Flexible hub portions 58 extend inwardly from inner cover surface 16. Flexible hub portions 58 are arcuate segments that cooperate together to define an outer diameter, and the outer diameter at some point preferably near the base is slightly smaller than the inner diameter of the central orifice 70 of the disc 56. Angular retention ridges 60, at their thickest point, have an outer diameter that is slightly greater than the inside diameter of the central orifice 70 of the disc 56, and at their innermost point have an outer diameter that is less than the inside diameter of the central orifice 70 of the disc 56. When the disc 56 is pushed slightly onto the disc retention hub 54 at the angular retention ridges 60, the inner diameter of the central orifice 70 of the disc 56 passes over the outer diameter of the angular retention ridges 60, which is smaller than the inner diameter of the central orifice 70 of the disc 56. As the disc 56 is pushed further, the central orifice 70 of the disc 56 engages the thicker portions of the angular retention ridges 60, causing the flexible hub portions 58 to flex inwardly. As the disc 56 is pressed further, the inner diameter of the central orifice 70 of the disc 56 clears the thickest portions of the angular retention ridges 60, and the flexible hub portions 58 flex outwardly, tending to return to their original alignment. As a result, the disc 56 is retained on the disc retention hub 54 until removal is desired. Removal is accomplished by simply pulling firmly on the disc, which reverses the retention process described above.

Further retaining and protecting the disc 56 are inner disc rest 62 and outer disc rest 64. Inner and outer disc rests 62 and 64 raise the disc 56 above the inner cover surface 16 in order to avoid having the inner cover surface 16 scratch the data portion 66 of disc 56. Inner disc rest 62 preferably is a raised circular lip extending upwardly from inner cover surface 16. The diameter of inner disc rest 62 is preferably less than the inner diameter of the data portion 66 of disc 56, and most preferably is the same diameter as and rests within the central groove 68 in the disc 56 that, in most DVDs (and CDs), lies between the data portion 66 and the central orifice 70 of the disc 56.

Outer disc rest 64 preferably includes a raised circular lip rest 72 extending inwardly from the inner cover surface 16, and peripheral disc edge guards 74 preferably integral with the circular lip rest 72 and also extending inwardly from the inner cover surface 16. Circular lip rest 72 preferably extends inwardly approximately the same distance as inner disc rest 62, and peripheral disc edge guards 74 extend inwardly an amount greater than the circular lip rest 72 and the inner disc rest 62, and preferably exceeds that inward amount by at least the thickness of the disc 56. The inner diameter of circular lip rest 72 of outer disc rest 64 preferably is approximately the same as or greater than the outer diameter of the data portion 66 of disc 56 when the disc 56 is retained on disc retention hub 56. The peripheral disc edge guards 74 of outer disc rest 74 are preferably accurate segments, and the inner diameter of the peripheral disc edge guards 74 are slightly larger than the outer diameter of disc 56 so as to prevent damage to the disc 56 caused by, for example, shifting of the disc should it inadvertently become dislodged from disc retention hub 54, and to deter theft from, for example, attempts to pry the case open from the edges.

As noted before, disc retention hub 54, inner disc rest 62, and outer disc rest 64, as well as their component parts, can be alternatively or additionally located on the inner base surface 20 without departing from the invention herein. In the embodiment illustrated in FIG. 1, those components are located on the inner base surface 20 as well.

Post 76 preferably may be located centrally to the disc retention hub 54 on either the inner base surface 20 or the inner cover surface 16. In the embodiment shown in FIG. 1, post 76 is attached to and extends inwardly from the inner base surface 20. Post 76 is preferably a cylinder approximately the same height as the width of spine 8 which, in turn, defines the depth of the inner cavity of multimedia security case 2. Post 76 thus helps prevent the multimedia security case 2 and disc 56 inside the case from being damaged should a force be applied centrally to cover 4 or base 6, such as by someone inadvertently placing something relatively heavy on the case. Post 76 also helps retain disc 56 should it become dislodged from disc retention hub 54 by preventing it from substantially sliding around the interior cavity of the multimedia security case 2, helping to prevent damage to or theft of the disc 56. Also located on inner cover surface 16 and inner base surface 20 are spanning reinforcement notches 90, which serve to reinforce base 6 and cover 4 to help prevent them from bending or warping, and to help prevent damage to or theft of the contents of multimedia security case 2.

Spine notches 78 extend upwardly from the inner spine surface 42 of spine 8 at intervals. Spine notches 78 add strength and rigidity to the spine 8, helping to prevent bending and warping of the spine 8. Spine notches 78 also serve to prevent or deter a common form of theft of discs from cases, namely, by using a razor blade to slice through the spine 8, cover hinge 10, or base hinge 12 to gain access to the contents. Were a person to attempt that means of theft from a multimedia security case 2 such as that illustrated in FIG. 1, spine notches 78 would render it more difficult to do so by making cut-through of the spine 8 more difficult and/or time-consuming.

Edge strengthening notches 82, and spine alignment notches 84 extend inwardly from the inner cover surface 16 and inner base surface 20, as illustrated in FIG. 1, and are preferably placed at intervals adjacent to the top and bottom cover edges 24 and 26, and adjacent to the spine 8, as illustrated therein, and similar strengthening notches may be located at other positions, for example, adjacent the lip retainers 38 and 40, or the cover and base side edges 26 and 32 (not illustrated), without departing from the invention. The edge strengthening notches 82 help strengthen top and bottom cover edges 24 and 26, and help keep them aligned. The spine alignment notches 84 help strengthen and align the spine 8, and also help prevent cut-through of the case at or near the cover hinge 10 and base hinge 12, the thinnest outer portions of the multimedia security case 2 if living hinges are utilized. Cut-through is deterred by the spine alignment notches 84 in the same manner as the spine notches 78 described previously.

Outer cover surface 14, outer base surface 18, or outer spine surface 86 may be decorated with informative materials about the disc inside, or may contain information about the proprietorship (e.g., the video rental store or library) in printed form that may be printed on or adhered to the outer cover surface 14, outer base surface 18, or outer spine surface 86 (such printing is not illustrated). Alternatively, a clear pouch (not illustrated) may be attached to the outer cover, base, or spine surfaces 14, 18, or 86, inside of which clear pouch such printed information may be inserted, displayed, and viewed.

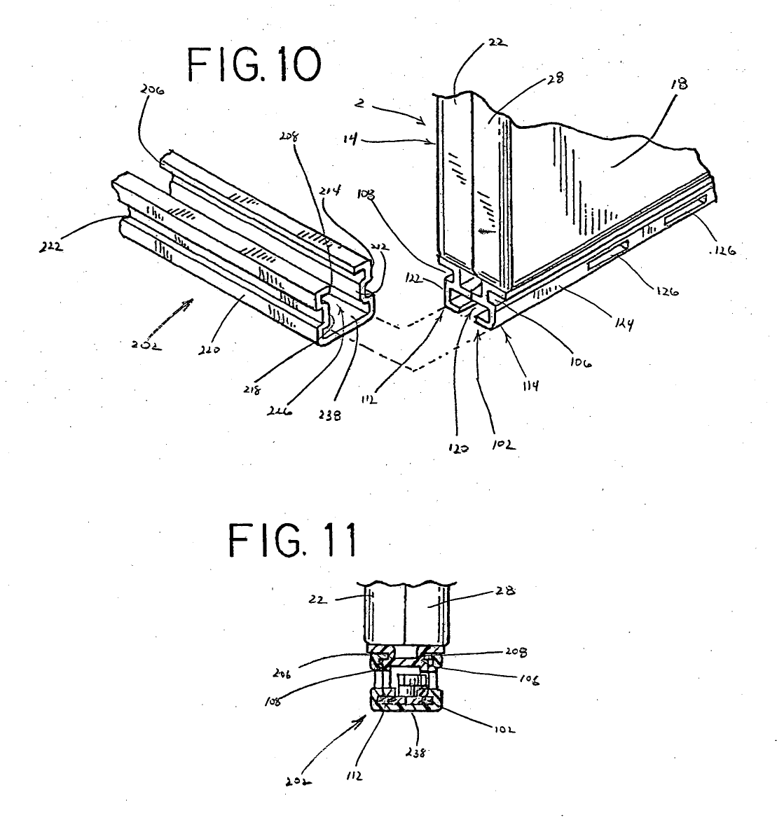

As illustrated in more detail in FIGS. 2 through 4, 10, and 11, and as previously discussed, multimedia security case 2 has a closed position. In that closed position, closure lips 50 of closure tabs 48 engage closure receptacles 52 (illustrated in FIG. 1) and maintain multimedia security case 2 in the closed position. While in that closed position, cover side edge 26 and base side edge 32 cooperate to form a flanged tongue 102 that accommodates slide lock 202, as described below. (See, in particular, FIG. 10). Adjacent flanged tongue 102 is a cover channel 104 and a base channel 106 integral with the cover side edge 26 and base side edge 32, and adjacent thereto, respectively. The cover channel 104 and base channel 106 are preferably substantially U-shaped, with the open side of the U-shape of each being open towards the outer cover surface 14 and the outer base surface 18, respectively. One edge of the U-shaped cover channel 104 preferably terminates at the outer cover surface 14, and, similarly, one edge of the U-shaped base channel 106 terminates at the outer base surface 18. One end (the same end, i.e., either both top ends, namely, the ends adjacent the top cover edge 22 and the top base edge 28, or both bottom ends, namely, the ends adjacent the bottom cover edge 24 and the bottom base edge 30) of each of the cover channel 104 and base channel 106 terminate at cover channel stop 108 and base channel stop 110, respectively. In the illustrated embodiment, the cover channel stop 108 and the base channel stop 110 are adjacent the bottom cover edge 24 and the bottom base edge 30, respectively; conversely, the ends of the channel opposite the cover channel stop 108 and base channel stop 110 are open ended and do not contain stops.

The edge of U-shaped cover channel 104 that is distal from the outer cover surface 14 is connected to and terminates at the cover flange half 112. Similarly, the edge of the U-shaped base channel that is distal from the outer base surface 18 is connected to and terminates at the base flange half 114. When the multimedia security case 2 is in the closed position, cover and base channels 104 and 106 are adjacent to cover and base flange halves 112 and 114, which together form flanged tongue 102. (See FIG. 10).

Preferably formed integrally with top flange half 112 and bottom flange half 114 are cover finger indent 116 and base finger indent 116, respectively, which are used to accommodate the fingers more easily during the opening of the multimedia security case 2 when it is unlocked. Cover flange half 112 and base flange half 114 are preferably formed so as to have substantially U-shaped cross-sections, with the U-shapes opening inwardly toward inner flange channel 120, and with the cross-section of the cover flange half 112 preferably being the mirror image of the cross-section of the base flange half 114 when viewed from the same side when multimedia security case 2 is in the closed position. As a result, when in the closed position, the cross-sections of cover flange half 112 and base flange half 114, taken together, define inner flange channel 120.

Formed on cover flange half top edge 122 and base flange half top edge 124 are at least one and preferably a plurality of locking bar receptacles 126, with the size and positions of the locking bar receptacles 126 on the cover flange half top edge 122 coinciding with the size and positions of the locking bar receptacles 126 on the base flange half top edge 124, so that when viewed perpendicular to either the cover or base half top edges 122 or 124, it appears as though there is an aperture straight through the cover and base tongue halves 112 and 114.

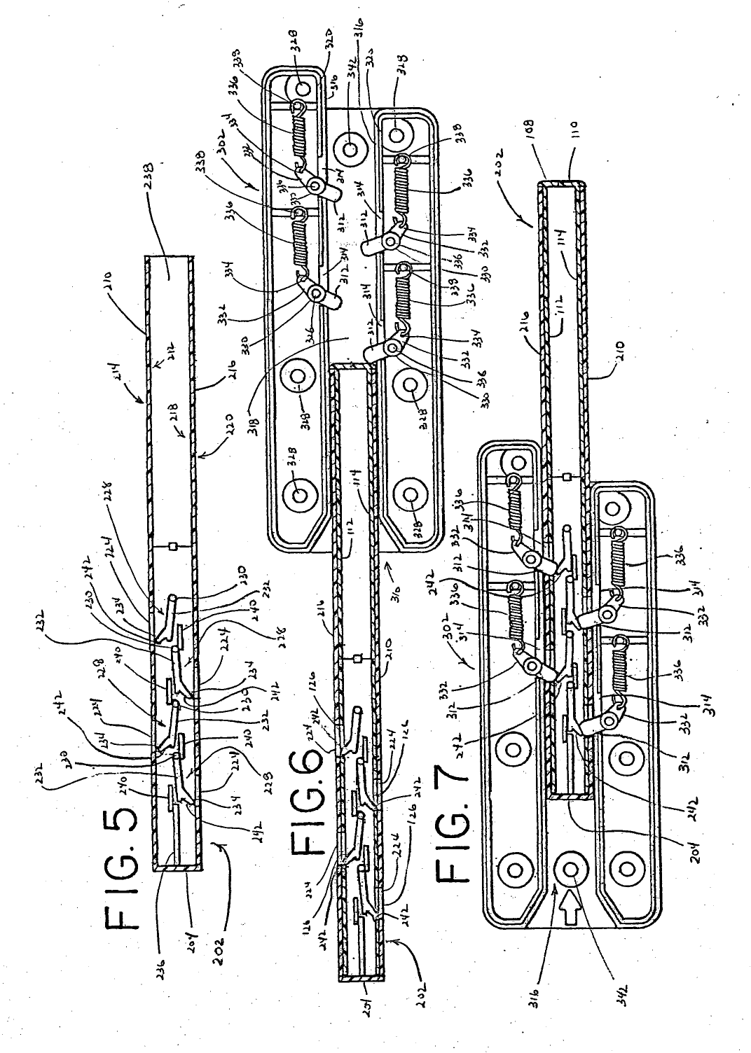

As shown in FIGS. 2 and 10, slide lock 202 is formed principally as a bar having a substantially C-shaped internal cross-section. Slide lock 202 has lock stop 204 attached to one end, preferably substantially interrupting, disrupting or closing the C-shaped cross section. The length of slide lock 202 is preferably approximately the same length as the cover side edge 26 and base side edge 32. Slide lock 202 has a cover channel rim 206 and a base channel rim 208 that are attached to and that extend inward towards locking bar channel 226 from lock cover edge 210 and lock base edge 216, respectively. Lock cover edge 210 has a lock cover edge inner surface 212 and lock cover edge outer surface 214. Lock base edge 216 has lock base inner surface 218 and lock base outer surface 220. When the slide lock 202 is in the locked position as shown in FIGS. 3, 4, 6, and 11, the inner edges of cover channel rim 206 and base channel rim 208 fit within, preferably snugly, and cooperate mechanically with cover channel 104 and base channel 106, respectively. Locking bar footing 238 is located between lock cover edge 210 and lock base edge 216. Cover channel rim 206, base channel rim 208, lock cover edge inner surface 212, lock base edge inner surface 218, and locking bar footing 238 define locking bar channel 226. Lock cover edge 210 and lock base edge 216 have lock outer grooves 222 formed in the lock cover edge outer surface 214 and lock base edge outer surface 220, respectively. Formed into each of the lock outer grooves 222 are locking bar access portals 224. As preferred, in the embodiment illustrated in FIGS. 2 through 4, a plurality of locking bar access portals 224 are formed as apertures in lock outer grooves 222. As illustrated, the number of locking bar access portals 224 formed in each of the two lock outer grooves 222 is preferably half the total number of locking bar receptacles 126 formed through the cover and base flange half top edges 122 and 124. Also as illustrated, the locations of the locking bar access portals 224 on the lock cover edge 210 preferably coincide with two non-adjacent locking bar receptacles 126 when the slide lock 202 is in the locked position (FIGS. 6 and 7), and the locations of the locking bar access portals 224 on the lock base edge 216 coincide with the two remaining non-adjacent locking bar receptacles 126 when the slide lock 202 is in the locked position. As shown in the illustrated embodiment, the locking bar receptacles 126, and hence the associated locking bar access portals 224, are preferably oriented approximately the same distance from the next adjacent locking bar receptacle 126 or access portal 224, respectively.

As illustrated in FIGS. 5 through 9, located adjacent the locking bar access portals 224 within the locking bar channel 226 are locking bars 228. Locking bars 228 include pivots 230, bias arms 232, and barbs 234. The pivots 230 of the locking bars 228, are located sufficiently inwardly of the lock cover edge inner surface 212 and lock base edge inner surface 218 so that the cover flange half 112 and base flange half 114 can fit between the lock cover and base edge inner surfaces 212 and 218, respectively, on the one hand, and the outermost edges of the pivots 230, on the other hand. (See FIGS. 6 and 7). Similarly, locking bars 228 and, in particular, bias arms 232 and barbs 234, are sufficiently flexible and of a sufficiently small size to permit the cover flange half 112 and base flange half 114 to fit between the lock cover edge inner surface 212 and lock base edge inner surface 218, on the one hand, and the locking bars 228 in an inwardly flexed position (see, e.g. FIG. 7), on the other hand. Moreover, locking bars 228 and, in particular, bias arms 232 and barbs 234, are of a sufficiently small size and are sufficiently inwardly flexible so as to fit within the inner flange channel 120 of the flanged tongue 102. Bias arms 232 are made of a material, such as preferably polycarbonate, that is flexible and biased outwardly sufficiently such that when slide lock 202 slides onto and engages the flanged tongue 102 of multimedia security case 2 when the case is in the closed position, the barbs engage the locking bar receptacles 126, as illustrated in FIG. 6. Locking bar stops 240 may be included to prevent locking bars 228 from being flexed too far and either disrupting the smooth operation of the slide lock 202 or damaging the locking bars 228. Locking bar stops 240 are sufficiently small to fit within flange channel 120.

Also located in the locking bar channel 226 proximate to locking bars 228 and preferably near one end of the locking bar channel 226, and most preferably adjacent lock stop 204, is locking bar alignment tab 236. Locking bar alignment tab 236 may be located in the axial center of locking bar channel 226, and is of a sufficiently small width to permit both the cover flange half 112 and the base flange half 114 to fit between the locking bar alignment tab 236, on the one hand, and the lock cover edge inner surface 212 and the lock base edge inner surface 218, on the other hand. Locking bar alignment tab 236 is also sufficiently small enough to fit within the inner flange channel 120 of flanged tongue 102. The height of locking bar alignment tab 236 is of a sufficient dimension to prevent portions of the multimedia storage case 2, such as the inward portions of the inner flange channel 120, flanged tongue 102, cover side edge 26 or base side edge 32, for example, from interfering with the flexibility and movement of locking bars 228.

Locking bars 228 are preferably oriented so that their barbs 234 are on the ends of locking bars 228 that are facing the lock stop 204 and their pivots 230 are facing away from lock stop 204. The barbs 234 of the locking bars 228 are biased toward locking bar access portals 224, which are preferably arranged in an alternating manner so that every other barb 234 is biased toward the lock cover edge 210, and the remaining barbs are biased outwardly toward the lock base edge 216.

In order to lock the multimedia security case 2, the invention works as follows. First, the multimedia security case 2 is placed in the closed position. (FIG. 2). Closure tabs 48 (FIG. 1) and in particular closure tab lips 50 engage closure receptacles 52 to maintain the case in the closed position. As previously described, and as illustrated in FIGS. 2 and 10, in the closed position, cover flange half 112 and base flange half 114 cooperate to form flanged tongue 102 having cover channel stop 108 and base channel stop 110 at one end of the flanged tongue 102, and an open end at the second end.

Slide lock 202 serves to lock multimedia security case 2 as follows. As shown in FIGS. 3, 4, 6, and, more particularly, 10, the end of slide lock 202 that does not have lock stop 204 slides onto the end of flanged tongue 102 that does not have cover and base channel stops 108 and 110. As slide lock 202 slides along flanged tongue 102, cover channel rim 206 and base channel rim 208 slide along and engage cover channel 104 and base channel 106, respectively. At the same time, lock cover edge inner surface 212 and lock base edge inner surface 218 slide along and engage cover flange half top edge 122 and base flange half top edge 124, respectively, preventing the cover flange half 112 from being separated from the base flange half 114. (See FIGS. 2, 3, 6, 10 and 11). As the slide lock 202 slides toward the cover and base channel stops 108 and 110, the locking bars 228 and locking bar alignment tab 236 pass within inner flange channel 120.

As slide lock 202 continues to slide along flanged tongue 102, the barbs 234, which are biased outwardly by bias arms 232 of locking bars 228 toward the cover and base half top edges 122 and 124, begin to fit into locking bar receptacles 126 located thereon. The shape of the barbs 234 permits the edges of the locking bar receptacles 126 to continue to slide over the barbs 234 only so long as the slide lock 202 slides in a direction toward cover and base channel stops 108 and 110. The shape of barbs 234 having catches 242 on the sides distal to cover and base channel stops 108 and 110, however, prevents the direction of sliding from being reversed, because the outwardly biased catches 242 of barbs 234 on locking bars 228 engage the edges of locking bar receptacles 126 so that the slide lock 202 cannot slide in a direction toward the open end of the cover and base channels 104 and 106. (E.g., FIG. 6). When the slide lock 202 slides onto flanged tongue 102 sufficiently so that slide lock 202 abuts cover and base channel stops 108 and 110, at the other end of the slide lock 202, preferably lock stop 204 abuts cover flange half 112 and base flange half 114.

At the same time, as illustrated in FIG. 6, at least one and preferably all of the locking bars 228 of the slide lock 202 become engaged with the locking bar receptacles 126 of cover flange half 112 and base flange half 114. The locking bar 202 cannot continue sliding off of the flanged tongue 102 in the original direction of sliding because cover channel stop 108, base channel stop 110, and lock stop 204 block the path of sliding. On the other hand, locking bar 202 cannot slide off of the flanged tongue 102 by reversing the direction of sliding because catches 242 of barbs 234 on locking bars 228 engage locking bar receptacles 126 so as to prevent such reverse sliding. And, as illustrated in FIGS. 3 and 11, slide lock 202 cannot be pulled or pried from the case because cover channel rim 206, lock cover edge inner surface 212, base channel rim 208, and lock base edge inner surface 218 are firmly engaged with, and effectively clamped onto, the cover channel 104, base channel 106, cover flange half 112, and base flange half 114, respectively. The slide lock 202 thus maintains the multimedia security case 2 in the closed position, and locks the case in that position. Short of destroying the multimedia security case 2 and/or the slide lock 202, the only practical way to disengage the slide lock 202 from the multimedia security case 2 and to reopen the case and remove its contents is to use the key 302, as described below.

As illustrated in FIGS. 4 and 6 through 9, key 302 preferably has a key base 304, a first key housing 306, a second key housing 308, and a key channel 310 located between the first and second key housings 306 and 308. Key channel 310 has key channel base 318 and key channel sides 320. A plurality of key teeth 312, preferably the same number as the number of locking bars 228, extend into the key channel 310 through key housing apertures 314 formed in key channel sides 320. Key channel guide ridges 316 are located preferably on the first and second key housings 306 and 308 on key channel sides 320 and extend into the key channel 310. The width of key channel 310 (the dimension between key channel sides 320) is slightly wider than the width of slide lock 202 and/or the multimedia security case 2 so that the multimedia security case 2 with the slide lock 202 locked onto it can slide through the key channel 310 with the slide lock 202 in the bottom of key channel 310. Key channel guide ridges 316 are located a height above the key channel base 318 and are of an appropriate width so as to engage lock outer grooves 222 of slide lock 202 when it slides through the key channel 310 in the manner illustrated, for example, in FIG. 4. Similarly, key teeth 312 are located a height above the key channel base 318, and are of an appropriate width and distance apart from one another, so that the key teeth 312 will fit within locking bar access portals 224 located in lock outer grooves 222 on slide lock 202 when it slides through the key channel 310 in that manner.

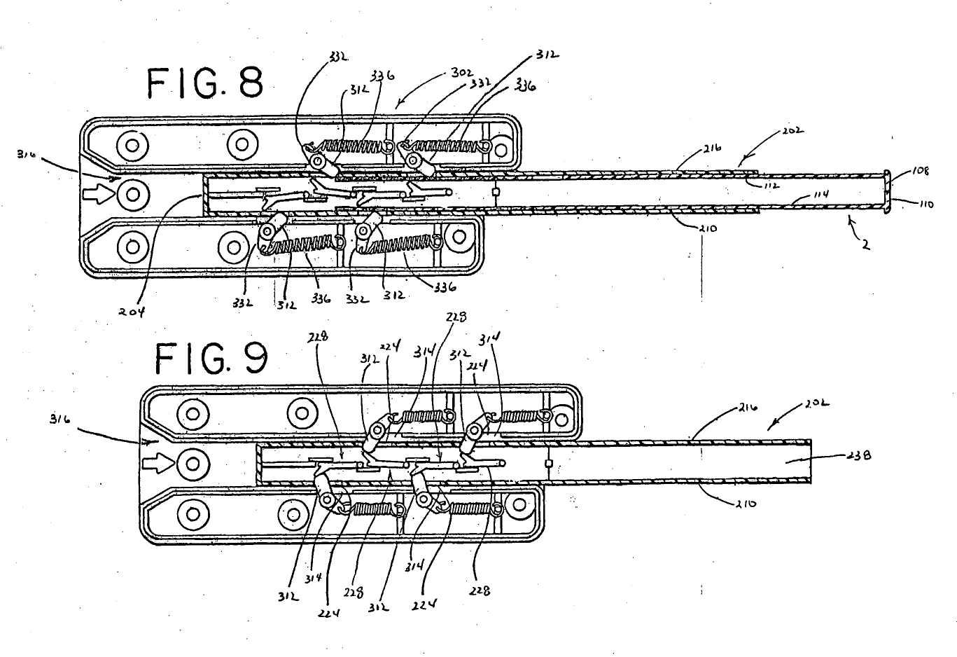

First and second key housings 306 and 308 preferably have removable first housing cover 322 and second housing cover 324, respectively, permitting access to and maintenance of the interior of the key 302. The first and second housing covers are preferably semi-permanently attached to the key base 304, such as by screws (not illustrated) through screw holes 328 (e.g., FIGS. 6 through 9), or by tabs or snap fits (not illustrated). Key teeth 312 are preferably situated so that, during the sliding that occurs during the unlocking process, they can swivel out of the path of the locked multimedia security case 2 as it slides through the key channel 310 in one direction (the unlocking direction) (see FIG. 8 and arrow illustrated therein), but cannot swivel in the opposite direction except to return to their original position. (See FIGS. 6 and 9). Moreover, key teeth 312 are biased in the opposite direction of the unlocking direction, as further described herein.

Attached to the key base 304 and/or the first and second key housings 306 and 308 are swivel rods 326. Key teeth 312 are attached to key teeth apertures 330 which are of a sufficient inside diameter to fit over swivel rods 326. Attached to and on the substantially opposite side of key teeth apertures 330 from key teeth 312 are spring arms 332 with spring retainers, preferably in the form of spring retaining orifice 334. A plurality of further spring retainers, preferably formed as spring retaining posts 338, are attached to either the key base 304 or the first or second key housings 306 and 308. Springs 336 are attached to spring arms 332 by hooking one end of each of the springs 336 through spring retaining orifices 334. The other ends of the springs 336 are looped around spring retaining posts 338. Springs 336 can be of the extension variety or the compression variety, and extension springs are used in the illustrated embodiment. In the event that compression springs were to be used to bias the key teeth 312, compression springs would be mounted on the opposite sides of spring arms 332, and spring retaining posts 338 would be located on the opposite side of spring arms 332 as well.

Key teeth 312 protrude sufficiently into key channel 310 so that, when the locked multimedia security case slides through the key 302 in the unlocking direction, key teeth 312 will engage and extend through locking bar access portals 224 and locking bar receptacles 126 a sufficient distance to cause catches 242 and barbs 234 on locking bars 228 to disengage from locking bar receptacles 126. (FIG. 7). This causes bias arms 232 on locking bars 228 to flex inwardly so that multimedia security case 2 slides relative to slide lock 202 in a direction toward cover and base channel stops 106 and 108 and the open end of locking channel 226. (FIGS. 7 through 9). Key teeth 312 do not protrude so far into key channel 310 that key teeth 312 will damage locking bars 228 or cause the locking bars 228 or the key teeth 312 themselves to interfere with the movement of multimedia security case 2 relative to slide lock 202. Key teeth 312 are prevented from swiveling in the direction opposite from the direction of sliding through the key channel 310 in the unlocking direction by the abutting side edges of key housing apertures 314. (E.g., FIG. 6). Because there are no abutting edges on the opposite side of key teeth 312, and key housing apertures 314 are more open on the non-abutting side, key teeth 312 are free to swivel in the direction of sliding (but not the opposite direction), subject to the opposing biasing force applied by springs 336 via spring arm 332 to key teeth 312. (See FIG. 8). The biasing force applied by bias arms 232 to catches 242 and barbs 234 on locking bars 228 is sufficient to overcome the biasing force applied by bias arm 232 to catches 242 and barbs 234 on locking bars 228 so that, when the key teeth 312 engage the locking bars 228, the key teeth 312 disengage the locking bars 228 of the slide lock 202 from the locking bar receptacles 126. This disengagement permits the multimedia security case 2 to slide relative to the slide lock 202 toward the open end of locking channel 226 of slide lock 202.

The key 302 operates to unlock a multimedia security case 2 in the locked condition, that is, a multimedia security case 2 with the slide lock 202 engaged with the flanged tongue 102 and with locking bars 228 engaging locking bar receptacles 126 (see FIGS. 3, 4, 6, and 11), as described below.

As shown in FIG. 4, in order to unlock multimedia security case 2 with slide lock 202 in place (locked), it slides through key 302 with the slide lock 202 proximate to the key base 304, and the spine 8 upwardly protruding from the key 302. The direction of sliding relative to the key 302, as indicated in FIGS. 4, and 6 through 8 (see arrows), is in the direction that key teeth 312 are permitted to swivel. The direction of sliding of the locked multimedia security case 2 relative to the key 302 is with the edge of the case having the open end of the locking bar channel 226 (the edge having cover channel stop 108 and base channel stop 110) being the leading portion of the locked multimedia security case 2 that slides through the key 302.

As shown in FIGS. 4 and 6 through 9, as sliding occurs and the locked multimedia security case 2 enters key 302, key channel guide ridges 316 engage lock outer grooves 222 so that the slide lock 202 and multimedia security case are properly aligned as the locked case slides further through the key 302. As the sliding continues, the portions of lock outer grooves 222 that do not have locking bar access portals 224 contact key teeth 312, causing the teeth to swivel around swivel rods 326 in the direction of sliding, and thereby causing spring arms 332 to rotate around swivel rods 326 in a direction away from springs 336, causing springs 336 to stretch. By stretching springs 336, key teeth 312 are biased in a direction opposite that of the direction of their swivel, that is, they are biased to return toward the lock outer grooves 222, in which the key teeth ride as the sliding continues. In the event that compression springs were to be used instead of extension springs, the rotation of spring arms 336 around swivel rods 326 would cause the compression springs, mounted on the opposite side of spring arms 332, to compress resulting in a biasing action in the same direction and in the same manner disclosed, with the same resulting action by the key teeth 312, and the same result.

When one or more key teeth 312 encounter a locking bar access portal 224 during the sliding process, the biasing force applied by the springs 336 to the key teeth 312 cause the key teeth 312 to swivel into and enter the locking bar access portals 224. Upon entering the locking bar access portals 224, which are aligned with corresponding locking bar receptacles 126, the key teeth 312 swivel into and enter the corresponding locking bar receptacles 126, and engage the corresponding locking bars 228, flexing them inwardly because springs 336 are chosen so that the biasing force of the springs 336 exceed the biasing force of the bias arms 232. In so doing, one or more key teeth 312 disengage the corresponding number of the catches 242 of barbs 234 on locking bars 228 from the locking bar receptacles 126. Unless all of the locking bars 228 are substantially simultaneously disengaged from locking bar receptacles 126 (see FIG. 7), the engaged locking bars 228 (those locking bars 228 of slide lock 202 that continue to be engaged with locking bar receptacles 126 of multimedia security case 2) will continue to maintain the slide lock 202 locked on the multimedia security case 2. In that circumstance (not illustrated), as the sliding action continues, the key teeth that formerly were in the locking bar access portals 224 swivel once again, upon once again encountering and engaging the lock outer grooves 222, and continue to glide in and engage the lock outer grooves 222 as the locked case continues to slide through the key 302, until one or more key teeth 312 engage the next locking bar access portals 224.

The process continues until, as illustrated in FIG. 7, the multimedia security case 2 with the slide lock 202 thereon reaches the position in the key 302 where key teeth 312 are aligned with all of the engaged locking bars 228 and substantially simultaneously engage all of the locking bar access portals 224 for the engaged locking bars 228. As a result and in the manner described above and illustrated in FIG. 7, the key teeth 312 substantially simultaneously disengage all of the locking bars 228 from the locking bar receptacles 126. When that happens, the slide lock 202 is no longer locked to the multimedia security case 2, because the multimedia security case 2 can now slide relative to slide lock 202 (the disengaged key teeth 312 no longer prevent such sliding). Slide lock 202, however, remains engaged with key teeth 312. Because multimedia security case 2 is no longer locked to slide lock 202, and because slide lock 202 remains engaged with key 302 (because key teeth 312 are engaged with locking bar access portals 224), as illustrated in FIG. 8, continued sliding action of the multimedia security case 2 in the unlocking direction causes the flanged tongue 102 of the multimedia security case 2 to begin to slide out of engagement with the slide lock 102. At the same time, the key teeth 312 also swivel sufficiently to disengage the locking bar receptacles 126, but the biasing force of the springs 336 causes the key teeth 312 to continue to engage the locking bar access portals 224, in turn causing the key 302 to hold the slide lock 202 while at the same time the multimedia security case 2 slides free of the slide lock 202. (FIGS. 8 and 9). As sliding continues, re-engagement of the locking bars 228 with other locking bar receptacles 126 is prevented by key teeth 312 which continue to engage the locking bars 228 and flex them inwardly into the locking bar channel 226 where the locking bars 228 cannot engage the locking bar receptacles 126. As sliding continues, the flanged tongue 102 of multimedia security case 2 becomes free of the slide lock 202 (FIG. 9), and the multimedia security case 2 becomes unlocked and can be opened. The biasing force of springs 336 on spring arms 332 causes key teeth 312 to return to their original position (compare FIG. 6 and FIG. 9).

After unlocking has occurred, the slide lock 202 may be disengaged from the key 302 in at least two ways. First, the slide lock 202 can be pulled manually through the key channel 310 in the direction of sliding, causing key teeth 312 to swivel in the direction of sliding, disengaging the locking bar access portals 224, and releasing the slide lock 202. Second, by sliding a second locked multimedia security case 2 into key channel 310, in order to unlock that second case, the second multimedia security case 2 will push the previous slide lock 202 in the direction of sliding, causing the key teeth 312 to swivel in that direction, disengaging the locking bar access portals 224, and releasing the previously retained slide lock 202. As can be seen, this second procedure would permit quick sequential unlocking of many locked multimedia security cases by, for example, a video rental store clerk or librarian, with the advantageous result of considerable time savings vis-à-vis the prior art.

In order to prevent loss or theft of the key 302, and to prevent the key 302 from moving when sliding forces are applied during the unlocking procedure, key 302 is preferably semi-permanently or permanently affixed to the checkout counter at the video rental store or library, such as by gluing using strong adhesive, or by using screws or nails through countersunk fastener holes 342.

Multimedia security case 2 and its component parts may be made out of a wide variety of plastics or other solid materials, and is preferably made of polypropylene. Slide lock 202 likewise may be made from a variety of plastics, metals, or other solids, and is preferably made of polycarbonate or acrylonitrile butadiene styrene (ABS) plastic. Key 302, with the exception of swivel rods 326 and springs 336, can be made of a number of different materials, including plastics or metals, and is preferably made from a polyamide resin material such as nylon or acetal resin material such as DELRIN® available from E.I. DuPont De Nemours & Co. Swivel rods 326 and springs 336 are preferably made of metal, such as steel.

Although the invention has been illustrated and described with respect to a detailed, exemplary embodiment thereof, it should be understood by persons skilled in the art that various changes in form, detail, methodology, or approach may be made without departing from the spirit and scope of the claimed invention. It should likewise be understood that while certain parts of the invention are referred to or described herein as “half” or “halves,” that description is not meant to imply that the two corresponding “half” parts are necessarily equal parts, but rather that each “half” part is one of a pair of corresponding parts.

Having thus described at least one exemplary embodiment of the invention, that which is new and desired to be secured by Letters Patent is claimed below.

1. A multimedia security case system comprising:
(A) a case having an open position and a closed position, the case having an internal cavity in the closed position, the internal cavity enclosing one or more retainers for multimedia systems, the case having a cover, a base, and a hinge disposed between the cover and the base enabling the case to be moved between the open position and the closed position,
(1) the cover having a cover flange half attached thereto, and the base having a base flange half attached thereto, the cover having a cover channel attached thereto and located between the cover and the cover flange half, and the base having a base channel attached thereto and located between the base and the base flange half, the cover flange half and the base flange half cooperating to form a flanged tongue having a first end and a second end when the case is in the closed position;
(2) the flanged tongue having an inner flange channel;
(3) the flanged tongue having a first slide stop thereon; and
(4) at least one of the cover flange half or the base flange half having one or more locking bar receptacles formed as apertures therethrough;
(B) a slide lock for engaging the flanged tongue of the case when the case is in the closed position by sliding the slide lock onto the flanged tongue, the slide lock having a lock cover edge, a lock base edge, and a locking bar footing disposed between the lock cover edge and the lock base edge;
(1) the lock cover edge having a lock cover edge inner surface and a lock cover edge outer surface, the lock base edge having a lock base edge inner surface and a lock base edge outer surface;
(2) the lock cover edge inner surface having a cover channel rim extending therefrom, and the lock base edge inner surface having a base channel rim extending therefrom;
(3) the cover channel rim, lock cover edge inner surface, locking bar footing, lock base edge inner surface, and base channel rim cooperating to defining a locking bar channel;
(4) at least one of the lock cover edge or the lock base edge having one or more locking bar access portals formed as apertures therethrough; and
(5) the locking bar footing having one or more locking bars located thereon within the locking bar channel, with each of the locking bars being adjacent one of the locking bar access portals, with each of the locking bars further including a pivot, a bias arm, and a barb, with each of the bias arms biasing the barb of the locking bar toward the locking bar access portal adjacent to each locking bar;
(6) the slide lock having a first end and a second end;
(7) the slide lock having a first slide stop block for engagement with the slide stop;
(8) the first end of the slide lock, when the case is in the closed position, being slidable onto the second end of the flanged tongue of the case in a first sliding direction toward the first end of the flanged tongue of the case until the first slide stop block of the slide lock engages the first slide stop of the flanged tongue, said engagement of the first slide stop and first slide stop block preventing the slide lock from sliding further in the first sliding direction, and with each of the locking bars, pivots, bias arms, and barbs of the slide lock fitting within the inner flange channel, at which point
(a) the lock cover edge inner surface of the slide lock firmly engages the cover flange half of the case, the cover channel rim of the slide lock firmly engages the cover channel of the case, the lock base edge inner surface of the slide lock firmly engages the base flange half of the case, and the base channel rim firmly engages the base channel of the case, and the locking bar footing prevents the lock cover edge and base cover edge of the slide lock from moving apart relative to each other, together cooperating to prevent the slide lock from being removed from the flanged tongue other than by sliding, and further preventing the case from moving to an open position other then by removal of the slide lock from the flanged tongue; and
(b) one or more barbs of the locking bars of the slide lock engage one or more locking bar receptacles of the case preventing the slide lock from sliding on the flanged tongue in a second sliding direction opposite the first sliding direction until each of the barbs become disengaged from the locking bar receptacles; and
(C) a key for removal of the slide lock from the case by disengaging each of the barbs of each of the locking bars of the slide lock from each of the locking bar receptacles of the case with which the locking bars were engaged, the key including
(1) a key channel defined by two key channel sides and a key channel base;
(2) one or more key teeth extending from the key channel sides into the key channel, the number of key teeth being at least the same number as the number of locking bars that engage the locking bar receptacles when the slide lock engages the flanged tongue by sliding onto the flanged tongue in the first sliding direction until the first slide stop block of the slide lock engages the first slide stop of the case, and wherein the key teeth pivot in a first unlocking direction from an extended first position to a less extended second position when the slide lock comes in contact with the key teeth in the key channel in the first unlocking direction, and the key teeth being biased so as to return to the extended first position when the slide lock no longer contacts the key teeth; and
(3) the key teeth being engageable with the locking bar access portals and being extendable therethrough when the slide lock engaged with the flanged tongue of the case slides through the key channel in the first unlocking direction, at which point the key teeth extending through the locking bar access portals also extend through the locking bar receptacles of the case and disengage the barbs of the locking bars from the locking bar receptacles, with the result that the slide lock is then capable of sliding along the flanged tongue in the second sliding direction relative to the case so that the slide lock may slide off of the flanged tongue of the case in the second sliding direction.

2. The multimedia security case system of claim 1 further comprising:
a plurality of locking bars, a plurality of locking bar receptacles, and a plurality of locking bar access portals, with the number of locking bars and locking bar access portals being the same.

3. The multimedia security case system of claim 2 further comprising:
the same number of key teeth as locking bars.

4. The multimedia security case system of claim 3 wherein:
the first slide stop further comprises a raised interruption in either the cover channel or the base channel at the first end of the flanged tongue, and the first slide stop block further comprises the first end of the slide lock.

5. The multimedia security case system of claim 1 further comprising:
a first lock outer groove extending lengthwise along the lock cover edge outer surface, and a second lock outer groove extending lengthwise along the lock base edge outer surface, with both the first lock outer groove and the second lock outer groove being aligned with the locking bar access portals located on the lock cover edge outer surface and the lock base edge outer surface; and
key channel guide ridges extending lengthwise along the key channel sides and aligned with each of the key teeth;
wherein the key channel guide ridges are capable of engaging the lock outer grooves when the locking bar engaged with the flanged tongue of the case slides through the key channel in the first unlocking direction resulting in the alignment of the key teeth with the locking bar access portals.

6. The multimedia security case system of claim 5 wherein:
each of the retainers for multimedia systems further comprises a disc retention hub capable of retaining a DVD, CD or video game disc.

7. The multimedia security case system of claim 1 further comprising:
a second slide stop on the slide lock being engageable with a second slide stop block on the the case so as to prevent further sliding of the slide lock along the flanged tongue in the first sliding direction when the second slide stop of the slide lock and the second slide stop block of the case are engaged.

8. The multimedia security case system of claim 7 wherein:
the second slide stop comprises a raised interruption in the locking bar channel at the second end of the slide lock, and the second slide stop block comprises the second end of the flanged tongue.

9. The multimedia security case system of claim 1 wherein:
one or more locking bar receptacles are formed as apertures through the cover flange half, and one or more locking bar receptacles are formed as apertures through the base flange half; and
one or more locking bar access portals are formed as apertures through the lock cover edge, and one or more locking bar access portals are formed as apertures through the base cover edge.

10. A multimedia security case system comprising:
(A) a case having an open position and a closed position, the case having an internal cavity in the closed position, the internal cavity enclosing one or more retainers for multimedia systems, the case having a cover, a base, and a hinge disposed between the cover and the base enabling the case to be moved between the open position and the closed position,
(1) the cover having a cover flange half attached thereto, and the base having a base flange half attached thereto, the cover having a cover channel attached thereto and located between the cover and the cover flange half, and the base having a base channel attached thereto and located between the base and the base flange half, the cover flange half and the base flange half cooperating to form a flanged tongue having a first end and a second end when the case is in the closed position;
(2) the flanged tongue having an inner flange channel;
(3) at least one of the cover flange half or the base flange half having a first slide stop thereon at the first end of the flanged tongue; and
(4) the cover flange half having one or more locking bar receptacles formed as apertures therethrough, and the base flange half having one or more locking bar receptacles formed as apertures therethrough;
(B) a slide lock, the slide lock having a first end and a second end, the slide lock being capable of engaging the flanged tongue of the case when the case is in the closed position by sliding the first end of the slide lock onto the second end of the flanged tongue and toward the first end of the flanged tongue in a first sliding direction, the slide lock further having a lock cover edge, a lock base edge, and a locking bar footing disposed between the lock cover edge and the lock base edge
(1) the lock cover edge having a lock cover edge inner surface and a lock cover edge outer surface, the lock base edge having a lock base edge inner surface and a lock base edge outer surface;
(2) the lock cover edge inner surface having a cover channel rim extending therefrom, and the lock base edge inner surface having a base channel rim extending therefrom;
(3) the cover channel rim, lock cover edge inner surface, locking bar footing, lock base edge inner surface, and base channel rim cooperating to defining a locking bar channel;
(4) the lock cover edge having one or more locking bar access portals formed as apertures therethrough; and the lock base edge having one or more locking bar access portals formed as apertures therethrough;
(5) the locking bar footing having one or more locking bars located thereon within the locking bar channel, with each locking bar being adjacent one of the locking bar access portals, and with each of the locking bars further including a pivot, a bias arm, and a barb, with each of the bias arms biasing the barb of the locking bar toward the locking bar access portal adjacent to each locking bar;
(6) the first end of the slide lock being engageable with the first lock stop so as to prevent further sliding of the slide lock along the flanged tongue in the first sliding direction when the first end of the slide lock and the first slide stop of the flanged tongue are engaged;
(7) the slide lock having a second slide stop being engageable with the second end of the flanged tongue so as to prevent further sliding of the slide lock along the flanged tongue in the first sliding direction when the second end of the flanged tongue and the second slide stop of the slide lock are engaged;
(8) the locking bars, pivots, bias arms, and barbs of the slide lock fitting within the inner flange channel;
(9) wherein, at the point at which either the first lock stop of the flanged tongue engages the first end of the slide lock when the slide lock slides along the flanged tongue of the case in the first sliding direction, or the second slide stop of the slide lock engages the second end of the flanged tongue when the slide lock slides along the flanged tongue of the case in the first sliding direction,
(a) the lock cover edge inner surface of the slide lock firmly engages the cover flange half of the case, the cover channel rim of the slide lock firmly engages the cover channel of the case, the lock base edge inner surface of the slide lock firmly engages the base flange half of the case, the base channel rim firmly engages the base channel of the case, and the locking bar footing prevents the lock cover edge and base cover edge of the slide lock from moving apart relative to each other, together cooperating to prevent the slide lock from being removed from the flanged tongue other than by sliding, and preventing the case from moving to an open position other than by removal of the slide lock from the flanged tongue; and
(b) one or more barbs of the locking bars of the slide lock engage one or more locking bar receptacles of the case preventing the slide lock from sliding on the flanged tongue in a second sliding direction opposite the first sliding direction until each of the barbs become disengaged from the locking bar receptacles; and
(C) a key for removal of the slide lock from the case, by disengaging each of the barbs of each of the locking bars of the slide lock from the locking bar receptacles of the case, the key including
(1) a key channel defined by two key channel sides and a key channel base;
(2) one or more key teeth extending from the key channel sides into the key channel, the number of key teeth being at least the same number as the number of locking bars that engage the locking bar receptacles when the slide lock engages the flanged tongue by sliding onto the flanged tongue in the first sliding direction until the first slide stop of the slide lock engages the first end of the flanged tongue of the case or the second slide stop of the slide lock engages the second end of the flanged tongue of the case, and
(3) the key teeth being engageable with the locking bar access portals and being extendable therethrough when the case with the locking bar engaged with the flanged tongue slides through the key channel in a first unlocking direction, at which point the key teeth extending through the locking bar access portals also extend through the locking bar receptacles of the case and disengage the barbs of the locking bars from the locking bar receptacles, enabling the slide lock to be capable of sliding on the flanged tongue in the second sliding direction relative to the case so that the slide lock may slide off of the flanged tongue of the case in the second sliding direction.

11. The multimedia security case system of claim 10 wherein:
the first slide stop further comprises a raised interruption in either the cover channel or the base channel at the first end of the flanged tongue, and the second slide stop of the slide lock comprises a raised interruption in the locking bar channel at the second end of the slide lock.

12. The multimedia security case system of claim 11 further comprising:
a first lock outer groove extending lengthwise along the lock cover edge outer surface, and a second lock outer groove extending lengthwise along the lock base edge outer surface, with both the first lock outer groove and the second lock outer groove being aligned with the locking bar access portals located on the lock cover edge outer surface and the lock base edge outer surface, respectively; and
key channel guide ridges extending lengthwise along both of the key channel sides and aligned with the key teeth;
wherein, when the case with the slide lock engaged with the flanged tongue slides through the key channel in the first unlocking direction, the key channel guide ridges engage the first lock outer groove and the second lock outer groove, resulting in the alignment of the key teeth with the locking bar access portals.

13. The multimedia security case system of claim 12 further comprising:
the same number of key teeth as locking bars.

14. The multimedia security case system of claim 12 wherein:
the key teeth pivot in the first unlocking direction from a fully extended first position to a less extended second position when the first lock outer groove or second lock outer groove of the slide lock engage the key teeth when the case with the slide lock engaged with the flanged tongue slides through the key channel of the key in the first unlocking direction, with the key teeth being biased so as to return to the fully extended first position when the first lock outer groove or the second lock outer groove of the slide lock are no longer engaged with the key teeth.

15. The multimedia security case system of claim 10 wherein:
the first slide stop of the flanged tongue of the case engages the first end of the slide lock and the second slide stop of the slide lock engages the second end of the flanged tongue of the case at substantially the same time when the first end of the slide lock slides along the flanged tongue of the case in a first sliding direction.

16. The multimedia security case system of claim 10 wherein:
each of the retainers for multimedia systems further comprises a disc retention hub capable of retaining a DVD, CD, or video game disc.
